(19) United States
(12) Patent Application Publication
(10) Pub. No.: US 2010/0059381 A1
(43) Pub. Date: Mar. 11, 2010

(54) APPARATUS FOR MEASURING THE TURBIDITY OF WATER

(76) Inventor: David Robert Vincent, Dorset (GB)

Correspondence Address: Iandiorio Teska & Coleman, 260 Bear Hill Road, Waltham, MA, 02451, US

(21) Appl. No.: 12/448,781

(22) PCT Filed: Jan. 7, 2008
(86) PCT No.: PCT/GB2008/000035

§ 371 Date: Jul. 7, 2009

(30) Foreign Application Priority Data
Jan. 11, 2007 (GB) 0700538.2

(51) Int. Cl. C02F 1/469; B03C 5/02

(52) U.S. Cl. 204/643

(57) ABSTRACT

Apparatus for measuring the turbidity of water, which apparatus comprises: (i) pressure reducer and flow controller means; (ii) calibration solution injection means (2); (iii) a variable dielectrophoresis drive particle filter (3), set to retain micro-organisms, and able to be turned on and off at a set frequency, periodically releasing any micro-organisms that have been retained; (iv) monitor means (4) which monitors the output of the filter (3) by optical particle detection; and (v) phase sensitive detection signal processing means for correlating an obtained turbidity signal with the state of the filter (3) and flow rate of the water through the apparatus.

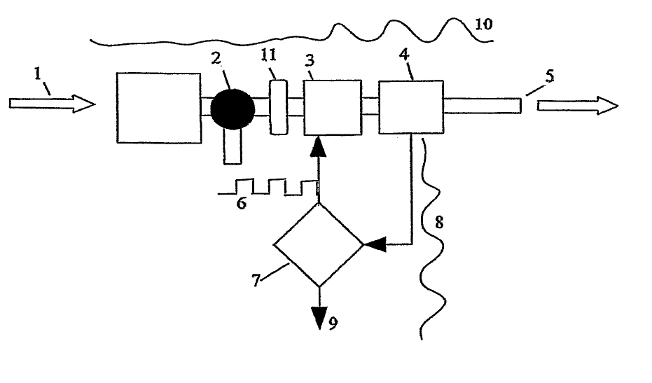

This invention relates to apparatus for measuring the turbidity of water.

There is growing concern over the quality of drinking water supplied to consumers through distribution networks. One of the types of potential contaminants of the drinking water is micro-organisms. These micro-organisms can break through filters at service reservoirs, or the micro-organisms can break through cracked pipes in the distribution networks. It is difficult and expensive to monitor the water for evidence of specific micro-organisms due to difficulties in identifying different types of the micro-organisms. Monitors are used which count particles in the water. This is because micro-organic contamination is generally associated with an increase in turbidity. The monitors have to be highly sensitive and they are expensive to manufacture. The monitors also require extensive maintenance because of the high level of accuracy required in their measurements, and also because of their low tolerance to fouling. Thus the deployment of these monitors is restricted. The monitors also provide no differentiation between organic and inorganic sources of turbidity.

Dielectrophoresis is a known technique that has become established for selectively moving and trapping organic particles in a sample volume of water. The technique works by driving a non-uniform alternating current electric field across a small gap. Uncharged organic particles polarize in the field and experience a force which can trap particles, or move them to one side of a chamber. The force depends upon the frequency, strength and direction of the electric field, thus affording some selectivity. Methods are known for directing a stream of organic particles either in a very well confined and narrow stream for optical detection and particle counting (with applications in cytometry), or for directing particles towards an evanescent wave optical detector. Apparatus is also known which retains particles and then releases the particles selectively, depending upon size and dielectrophoresis conditions. This apparatus produces a spectrum of a particle counter characteristic of the organic particles. All of the above known apparatus is complex and expensive.

It is an aim of the present invention to reduce the above mentioned problems.

Accordingly, in one non-limiting embodiment of the present invention there is provided apparatus for measuring the turbidity of water, which apparatus comprises:
(i) pressure reducer and flow controller means;
(ii) calibration solution injection means;
(iii) a variable dielectrophoresis drive particle filter, set to retain micro-organisms, and able to be turned on and off at a set frequency, periodically releasing any micro-organisms that have been retained;
(iv) monitoring means which monitors the output of the filter by optical particle detection; and
(v) phase sensitive detection signal processing means for correlating an obtained turbidity signal with the state of the fitter and flow rate of the water through the apparatus.

The apparatus of the present invention may be produced in a cost-effective manner. The apparatus may operate with improved water monitoring sensitivity to organic particles in a flow of water, thereby providing an indication of harmful contamination in the water, for example an indication of harmful contamination in drinking water. The use of flow control and calibration solution injection is to improve accuracy and long term stability.

The apparatus of the present invention will usually be used with potable water but it may be used to measure the turbidity of other types of water. The apparatus measures the micro-organic particulate contamination as an indication of the turbidity. The apparatus may measure the turbidity of a flowing sample of water, with enhanced sensitivity to micro-organic particulate contamination, and an improved lower limit of detection, as compared with various types of known apparatus.

The monitor means is preferably a turbidity monitor means. Other types of monitor means may however be employed so that, for example, the monitor means may be any suitable monitor means that operates by light-scattering particle detection or light absorbance. Thus the monitor means may be a light scattering monitor means or a light absorbance monitor means. The light scattering monitor means may use fluorescence.

The phase sensitive detection signal processing means may operate to cause a delay phase in the two signals. Any micro-organic particles that are trapped in the filter are able to be released as a block, increasing the signal.

The apparatus of the present invention may include phase sensitive detection means for use over a number of cycles in order to enhance the signal to noise ratio.

The apparatus may include ultrasonic separation means which is positioned before the filter and which aids in separating organic and inorganic particles. The ultrasonic separation means may operate to provide a form of emulsification.

The apparatus may include absorbance means for improving sensitivity of the apparatus. The absorbance means may be infrared absorbance means, or blue or ultra-violet light absorbance means. Absorbance means of other frequencies may be employed. The apparatus may include other optical light scattering means, including fluorescence.

An embodiment of the invention will now be described solely by way of example and with reference to the accompanying drawing which shows apparatus for measuring the turbidity of water.

Referring to the drawing, there is shown apparatus for measuring the turbidity of water. The apparatus shows a water sample inlet 1, and a flow control 2 providing calibration solution injection when required. A controllable dielectrophoresis filter 3 is provided. This filter 3 receives a control signal 6 which modulates particle concentration 10. The particle concentration 10 is monitored and detected by monitor means in the form of a turbidity monitor 4. The turbidity monitor 4 may include other sensors for absorbance at different wavelengths.

During operation of the apparatus shown in the drawing, the sample water discharges to waste 5, and has an output signal 8. The output signal 8 is correlated by a controller 7 in order to produce an output signal 9.

An ultrasonic emulsifier 11 is an optional feature which may be provided in front of the filter 3 in order to separate organic and inorganic particles.

It is to be appreciated that the embodiment of the invention described above with reference to the accompanying drawing has been given by way of example only and that modifications may be effected. It is also to be appreciated that the features (i)-(v) given above for the apparatus of the present invention may be used singly or in any combination.

1. Apparatus for measuring the turbidity of water, which apparatus comprises:
(i) pressure reducer and flow controller means;
(ii) calibration solution injection means;
(iii) a variable dielectrophoresis drive particle filter, set to retain micro-organisms, and able to be turned on and off at a set frequency, periodically releasing any micro-organisms that have been retained;
(iv) monitor means which monitors the output of the filter by optical particle detection; and
(v) phase sensitive detection signal processing means for correlating an obtained turbidity signal with the state of the filter and flow rate of the water through the apparatus.

2. Apparatus according to claim 1 in which the monitor means is a turbidity monitor means.

3. Apparatus according to claim 1 in which the monitor means is light scattering monitor means.

4. Apparatus according to claim 1 in which the monitor means is a light absorbance monitor means.

5. Apparatus according to claim 1 and including phase sensitive detection means for use over a number of cycles in order to enhance signal to noise ratio.

6. Apparatus according to claim 1 and including ultrasonic separation means which is positioned before the filter and which aids in separating organic and inorganic particles.

7. Apparatus according to claim 1
and including absorbance means for improving sensitivity of the apparatus.

8. Apparatus according to claim 7 in which the absorbance means is infrared
absorbance means.

9. Apparatus according to claim 7 in which the absorbance means is blue or ultra-violet light absorbance means.
